(19) United States
(12) Patent Application Publication
(10) Pub. No.: US 2014/0282061 A1
(43) Pub. Date: Sep. 18, 2014

(54) METHODS AND SYSTEMS FOR CUSTOMIZING USER INPUT INTERFACES

(71) Applicant: United Video Properties, Inc., Santa Clara, CA (US)

(72) Inventors: David John Wheatley, Tower Lakes, IL (US); Brian Craig Peterson, Barrington, IL (US); William J. Korbecki, Crystal Lake, IL (US); Jonathan Arme, Frankfort, IL (US); Douglas James Seyller, Lisle, IL (US); Thomas Steven Woods, Arlington Heights, IL (US); Mycal Elliott, Chicago, IL (US); Amanda Mallardo, Streamwood, IL (US); Justin Wear, Philadelphia, PA (US)

(73) Assignee: United Video Properties, Inc., SANTA CLARA, CA (US)

(21) Appl. No.: 13/828,375

(22) Filed: Mar. 14, 2013

(51) Int. Cl. G06F 3/0481

(52) U.S. Cl. CPC G06F 3/0481
USPC 715/745

(57) ABSTRACT

Methods and systems are provided for determining a suitable user input interface type based on a particular user. Specifically, a media guidance application determines a demographic category of a user, and based on that demographic category of the user, automatically selects a user input interface for manipulating media objects that is suitable for the user.

### BACKGROUND

Conventional systems allow users to access media guidance through a plurality of user input interfaces. Furthermore, as the costs associated with producing different types of interfaces continues to decrease, user devices often incorporate multiple types of user input interfaces. For example, user devices may incorporate one or more physical buttons, touchscreens, motion controls, etc. to receive user inputs. However, despite the increase in use of various types of user input interface types, not all potential users are capable of using every type of available user input interface.

### SUMMARY

Accordingly, methods and systems are provided herein for determining a suitable user input interface type based on a particular user. Specifically, a media guidance application determines a demographic category of a user, and, based on that demographic category of the user, automatically selects a user input interface type for manipulating media objects that is suitable for the user.

For example, if a young child does not have the dexterity and/or comprehension to operate a touch screen, or particular operations of a touch screen (e.g., swipes, pinches, etc.), the media guidance application automatically selects a user input interface type that the young child does have the dexterity (e.g., hand-eye coordination) and/or compression (e.g., understanding that particular interactions with the user device manipulates media objects) to operate. Furthermore, the particular user input interface type may be coupled with functions, media assets, and/or design elements also suitable for the user. For example, an elderly user may have the comprehension necessary to understand swipes or pinches on a touchscreen, but not necessarily the dexterity to perform the operations required by all user input interface types.

In some embodiments, the media guidance application may also customize the user input interface type as well. For example, the media guidance application may generate larger areas that can be touched to accept user inputs or relax the requirements for valid inputs (e.g., instruct the control logic to accept incomplete, non-continuous, and/or jagged swipe motions) to accommodate the user.

In some embodiments, the media guidance application, implemented on a user device with a plurality of user input interface types (e.g., motion-control, touch-screen actions, text entry, etc.), may determine a demographic category of a user. Based on the determined demographic category, the media guidance application may automatically select one of the plurality of user input interface types, in which each of the plurality of user input interface types defines a user interaction for manipulating a media object. The media guidance application then assigns the selected user input interface type to the media object such that, upon receiving user interaction associated with the user input interface, the media object is manipulated.

In some embodiments, when selecting a user input interface, the media guidance application may determine a dexterity rating, indicating a level of coordination of a user based on the demographic category, and compare the dexterity rating for the user to a threshold dexterity rating for the user input interface type, in which the threshold dexterity rating indicates a level of coordination necessary to use the first user input interface type. The media guidance application may then select the user input interface only after determining that the dexterity rating for the user exceeds the threshold dexterity rating. If it does not exceed the threshold dexterity rating, the media guidance application may select a user input interface associated with a lower threshold dexterity rating.

In some embodiments, when selecting a user input interface, the media guidance application may determine an interface comprehension level for the user based on the demographic category and compare the interface comprehension level to a threshold interface comprehension level, which quantifies a level of comprehension users need to have to understand the user input interface type. The media guidance application may then select the user input interface only after determining that the interface comprehension level for the user exceeds the threshold interface comprehension level. If it does not exceed the threshold dexterity rating, the media guidance application may select a user input interface with a lower threshold comprehension level.

In some embodiments, the media guidance application may further customize the functions accessible to a user based on the demographic category. For example, upon cross-referencing the demographic category of the user with a database associated with interface functions, the media guidance application may identify an interface function (e.g., playing a media object, performing playback alteration operation on the media object, searching for the media object, etc.) suitable for the demographic category. Additionally or alternatively, the media guidance application may customize the media assets and/or design elements of the interface based on the demographic category of the user.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a media guidance application in accordance with some embodiments of the disclosure;

FIG. 2 shows another illustrative example of a media guidance application in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5A shows an illustrative example of a display featuring a user input interface type customized based on a demographic category of a user in accordance with some embodiments of the disclosure;

FIG. 5B shows an illustrative example of a display featuring additionally user input interface types, functions, media assets, and design elements of the display of FIG. 5A, each customized based on a demographic category of a user in accordance with some embodiments of the disclosure;

FIG. 5C shows an illustrative example of a display featuring additionally user input interface types, functions, media assets, and design elements of the display of FIG. 5B, each customized based on a demographic category of a user in accordance with some embodiments of the disclosure;

FIG. 6 is a flowchart of illustrative steps for customizing a user input interface type based on a demographic of a user in accordance with some embodiments of the disclosure; and

FIG. 7 is a flowchart of illustrative steps for assigning a particular user input interface type to a media object in accordance with some embodiments of the disclosure.

### DETAILED DESCRIPTION OF DRAWINGS

Methods and systems are provided herein for determining a suitable user input interface type based on a particular user. Specifically, a media guidance application determines a demographic category of a user, and, based on that demographic category of the user, automatically selects a user input interface type for manipulating media objects that is suitable for the user.

An application that provides guidance through an interface that allows users to efficiently navigate content selections, easily identify content that they may desire, and present the content is referred to herein as an interactive media guidance application or, sometimes, a media guidance application or a guidance application. Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content.

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

As used herein, a “user input interface type” refers to any means for interacting with media objects presented by the media guidance application. For example, a user input interface type may refer to either an input device (e.g., remote control, mouse, trackball, keypad, keyboard, touch screen, touchpad, stylus input, joystick, voice recognition interface, joy-stick, game controller, image recognition interface, motion-sensing and/or motion-control interface, and/or other user input interface) or may refer to actions performed on input devices (e.g., single or double clicks, press-and-holds, motion-controls, including particular motions, touch-screen operations, including, but not limited to, swipes, drag-and-drops, pinch-and-expand, stylus inputs, video/audio/voice recognition, text entry, etc.).

As used herein, a “demographic category” refers to a subset of users defined by having (or not having) one or more similar characteristics. Demographic characteristics may include, but are not limited to, gender, age, ethnicity, knowledge of languages, disabilities, mobility, education level, employment status, location, learned skills sets, etc. In some embodiments, a demographic category may be determined based on demographic data, which may include or imply one or more demographic characteristics.

For example, certain demographic categories may not be able to operate all types of user input interface types both easily and efficiently. For example, certain demographic categories (e.g., young child) may not have the motor control necessary to operate a motion-control user input interface type. Therefore, the media guidance application may determine that the user input interface type assigned should not include motion-control. In another example, the demographic category may not have the comprehension necessary to understand that particular user interactions (e.g., swiping a touch-screen) manipulates a media object in a particular way (e.g., performs a scroll). Therefore, the media guidance application may determine that the user input interface type assigned should not include touch-screen operations other than touching a media object to select the media object. In another example, the media guidance application may determine that the user is blind. In response, the media guidance application may assign a user input interface that includes only audio commands (e.g., heard and spoken by the user) and/or physical buttons that may physically indicate (e.g., include braille) operations that may be performed.

In some embodiments, the media guidance application may also customize the user input interface type based on the demographics of the user. For example, the media guidance application may determine that the user has a handicap, which limits his or her dexterity. Therefore, while the user may perform the operations (e.g., swipes, pinches, etc.) necessary for a particular user input interface type, performing the operations may present a higher degree of difficulty. In response, the media guidance application may customize the user input interface to decrease the difficulty. For example, the media guidance application may generate larger areas that can be touched to accept user inputs or relax the requirements for valid inputs (e.g., instruct the control logic to accept incomplete, non-continuous, and/or jagged swipe motions) to accommodate the user.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens.

In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

In some embodiments, the media guidance application may assign a user input interface to a media object. As used herein, a “media object” refers to human-readable and/or human-recognizable data that may be manipulated by a user operating a user device upon which the media guidance application is implemented. A media object may be a variable, function, or file. For example, a media object may include, but is not limited to, a media asset (e.g., as described above) or a function of the media guidance application (e.g., to play a media asset, to perform a playback alteration operation on a media asset, to search for data, to post data on-line, to generate recommendations featuring media objects and/or media assets, to enable parental controls, to download data, or to enable display of a media asset and/or media object on another device).

A media guidance application may present or provide access to numerous media assets and/or media objects. In addition, a media guidance application may present or provide numerous functions (i.e., operations that may be performed on a media assets and/or media object). One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

FIGS. 1-2 show illustrative display screens that may be used to provide media guidance data. The display screens shown in FIGS. 1-2 and 5A-C may be implemented on any suitable user equipment device or platform. While the displays of FIGS. 1-2 and 5A-C are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, selectable option 204 is selected. Selectable option 204 corresponds to initiating a custom interface. For example, the media guidance application may generate display 500 (FIG. 5A) in response to the selection of selectable option 204. In display 200 the listings may provide interface design elements including cover art, still images from the content, video clip previews, live video from the content, fonts, colors, graphics, styles, or other types of decoration and/or ornamentation that indicate and accentuate the content being described by the media guidance data and presented by the media guidance application. Each of the graphical listings may also be accompanied by text to provide further information about the content associated with the listing. For example, listings 208, 210, and 212 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user input interface type, such as a remote control, mouse, trackball, keypad, keyboard, touch screen, touchpad, stylus input, joystick, voice recognition interface, image recognition interface, motion-sensing and/or motion-control interface, and/or other user input interface type discussed herein. It should be noted that embodiments herein may include multiple user input interface types or a user input interface, which incorporates multiple types of user input interfaces.

In some embodiments, the media guidance application may receive and/or detect demographic data about a user. For example, the media guidance application may actively or passively monitor the user to build a profile of demographic data of the user. For example, the media guidance application may receive demographic data via user inputs describing the user. Additionally or alternatively, the media guidance application may passively gather information about the user from sources that may be indicative of demographic data of a user (e.g., search histories, on-line profiles, accounts associated with the user, user data repositories, etc.).

For example, the media guidance application may incorporate or have access to one or more content-recognition modules, which may be used by the media guidance application to analyze information received from a content capture device (e.g., video and/or audio recorder). For example, the media guidance application may include an object recognition module. The object recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to determine the objects in and/or characteristics of video and audio content. For example, the media guidance application may receive a media asset in the form of a video (e.g., an audio/video recording of a user). The video may include a series of frames. For each frame of the video, the media guidance application may use an object recognition module to determine demographic data associated with the user from each frame (or the media assets as a whole) of the video.

In some embodiments, the content-recognition module or algorithm may also include audio analysis and speech recognition techniques, including, but not limited to, Hidden Markov Models, dynamic time warping, and/or neural networks (as described above) to process audio data and/or translate spoken words into text. The content-recognition module may also use any other suitable techniques for processing audio and/or visual data. For example, the content-recognition module may analyze audio data to determine a likely age, ethnicity, language spoken by the user, etc.

In addition, the media guidance application may use multiple types of optical character recognition and/or fuzzy logic, for example, when comparing multiple data fields (e.g., as contained in databases described below).

For example, the media guidance application may arrange the text into data fields and cross-reference the data fields with other data fields (e.g., in a lookup table database). Using fuzzy logic, the system may determine two fields and/or values to be identical even though the substance of the data field or value (e.g., two different spellings) is not identical. In some embodiments, the system may analyze particular data fields of a database for particular values or text. Furthermore, the data fields could contain values (e.g., the data fields could be expressed in binary or any other suitable code or programming language) other than human-readable text.

Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIG. 5A shows an illustrative example of a display featuring a user input interface type customized based on a demographic category of a user. It should be noted that display 500 is illustrative only and should not be taken to be limiting in any manner. For example, in some embodiments, one or more of the features of display 100 and/or display 200 may be incorporated into display 500. In some embodiments, display 500 may appear on the display (e.g., display 312 (FIG. 3)) of a user equipment device (e.g., user equipment device 402, 404, and/or 406 (FIG. 4)). Moreover, the media application may use one or more steps from one or more of the processes described in FIGS. 6-7 below to generated display 500 or any of the features described therein.

Display 500 represents an example of media guidance application assigning user input interface type (i.e. touch-screen icons) to various media objects based on a user in a young child demographic. For example, the user input interface type (e.g., large, touch-screen buttons) for media object 508 is both easy to access (e.g., requiring a minimal amount of dexterity) and easy to understand (e.g., requires a minimal amount of interface comprehension).

Display 500 represents multiple types of customization. First, the media guidance application has customized display 500 by requiring only touch interactions (e.g., a user placing his or her finger on media object 508) to manipulate (i.e. select) a media object (e.g., media asset 508) to trigger a function (e.g., playback) related to a media asset (e.g., media asset 504). The media guidance application has limited the user input interface types to only a single, easy access user input interface type in response to determining that the demographic category associated with the user is likely to have a low amount of dexterity and interface comprehension.

Second, the media guidance application has customized the user input interface type itself based on the demographic of the user (i.e. young child) having a low dexterity rating (e.g., the user is unlikely to have precise hand-eye coordination). Accordingly, the media guidance application will register a user interaction if the user touches media object 508, and will also register a user interaction if the user touches any place located within the boundaries of media asset 504.

Third, the media guidance application has customized the functions provided by display 500. For example, display 500 is limited to only playback operations. Fourth, the media guidance application has customized the media assets (e.g., media asset 502 and 504) of display 500 by displaying only media assets that are recommended for children and that are available without charge.

Finally, the media guidance application has customized the design elements of display 500 by including textual indicators of required user interactions (e.g., touching touch-screen buttons) to manipulate particular media objects. For example, media object 510 informs a user to “PICK A MOVIE” in a child-like font. While the media guidance application may determine that instructions to select a media asset would be unnecessary for a user in a different demographic category, the media guidance application has added media object 506 to help the user understand what he or she can do from display 500. Likewise, media object 508 includes a textual indicator of “Press Here!”, aiding the user in understanding where to touch the display screen (e.g., display 312 (FIG. 3)) of the user device (e.g., user equipment device 402, 404, and/or 406 (FIG. 4)), upon which the media guidance application is generating (e.g., via control circuitry 304 (FIG. 3)) display 500.

FIG. 5B shows an illustrative example of a display featuring additional user input interface types, functions, media assets, and design elements of the display of FIG. 5B, each customized based on a demographic category of a user. It should be noted that display 510 is illustrative only and should not be taken to be limiting in any manner. For example, in some embodiments, one or more of the features of display 100 and/or display 200 may be incorporated into display 510. In some embodiments, display 510 may appear on the display (e.g., display 312 (FIG. 3)) of a user equipment device (e.g., user equipment device 402, 404, and/or 406 (FIG. 4)). Moreover, the media application may use one or more steps from one or more of the processes described in FIGS. 6-7 below to generate display 510 or any of the features described therein.

Display 510 represents an example of media guidance application assigning multiple user input interface types (i.e. touch-screen buttons and swipes) to various media objects based on a user in an adolescent demographic. For example, the user input interface types (e.g., medium-sized, touch-screen buttons and swipes) for media object 514 and media object 516 is both relatively easy to access (e.g., requiring a mild amount of dexterity) and are relatively easy to understand (e.g., require interface comprehension of both touch inputs and swipe input commands).

Similar to display 500 (FIG. 5A), display 510 represents multiple types of customization. First, the media guidance application has customized display 510 by enabling multiple user input interface types (e.g., touch-screen buttons and swipes) to manipulate (i.e. select or perform) a media object (e.g., media asset 514 or media object 516) to trigger a function (e.g., receiving information or scrolling) related to a media asset. The media guidance application has limited the user input interface types to only two in response to determining that the demographic category associated with the user (e.g., an adolescent child) is likely to have only a medium amount of dexterity and comprehension. Accordingly, a user may only touch or swipe the display screen (e.g., display 312 (FIG. 3)) of the user device (e.g., user equipment device 402, 404, and/or 406 (FIG. 4)), upon which the media guidance application is generating (e.g., via control circuitry 304 (FIG. 3)) display 510 to interact with media objects.

Second, the media guidance application has customized the user input interface type itself based on the demographic of the user (i.e. adolescent child) having a high dexterity rating (e.g., the user is likely to have precise hand-eye coordination). Accordingly, the media guidance application will register a user interaction if the user touches the media object 514, but will not register an interaction if the user touches outside media object 514.

Third, the media guidance application has customized the functions provided by display 500. For example, display 510 includes playback operations, recording operations, information operations, and scrolling operations. Fourth, the media guidance application has customized the media assets (e.g., media asset 502 and media asset 512) of display 510 by displaying only media assets recommended for adolescent children and below and which are available without charge.

Finally, the media guidance application has customized the design elements of display 500 by removing textual indicators of required user interactions to manipulate some media objects (e.g., touching touch-screen buttons), but has included textual indicators of required user interactions to manipulate other media objects (e.g., swipes to perform scroll operations). For example, media object 514 informs a user that “Info” is available. However, based on the determined interface comprehension level of the user, the media guidance application determines that additional instructions are not necessary. In contrast, a user input interface type of a swipe is more complicated, the media guidance application has included textual and graphic indicators for this operation. Specifically, media object 516 includes “Swipe This Way For More Options” and an arrow to indicate to the user that a scroll operation may be performed by swiping.

FIG. 5C shows an illustrative example of a display featuring additional user input interface types, functions, media assets, and design elements of the display of FIG. 5B, each customized based on a demographic category of a user. It should be noted that display 520 is illustrative only and should not be taken to be limiting in any manner. For example, in some embodiments, one or more of the features of display 100 and/or display 200 may be incorporated into display 520. In some embodiments, display 520 may appear on the display (e.g., display 312 (FIG. 3)) of a user equipment device (e.g., user equipment device 402, 404, and/or 406 (FIG. 4)). Moreover, the media application may use one or more steps from one or more of the processes described in FIGS. 6-7 below to generate display 520 or any of the features described therein.

Display 520 represents an example of media guidance application assigning numerous user input interface types (e.g., touch-screen buttons, swipes, pinches, etc.) to various media objects based on a user in a teenager demographic. For example, the user input interface type (e.g., small, touch-screen buttons) for media object 522 requires a high amount of dexterity (relative to the dexterity of a child or other demographic categories) and is difficult to understand without prior knowledge of the user input interface types. For example, display 520 does not include directions indicating that touches, swipes, pinches, etc. are acceptable methods to manipulate media objects, and without prior knowledge that such user input interface types are generally acceptable, a user would not know to use these user input interface types.

Similar to display 500 (FIG. 5A) and display 510 (FIG. 5B), display 520 represents multiple types of customization. First, the media guidance application has customized display 520 by allowing multiple user input interface types (e.g., touch-screen buttons, swipes, pinches, etc.) to manipulate (i.e. select) media objects (e.g., media object 522, media object 526, media object 524, etc.) to trigger a function (e.g., playback, search, contract, etc.) related to a media asset (e.g., media object 522). In display 520, the media guidance application has enabled all available user input interface types in response to determining that the demographic category associated with the user, a teenager, is likely to have a high amount of dexterity and interface comprehension.

Second, the media guidance application has customized the user input interface type itself based on the demographic of the user (i.e. teenager) having a high dexterity rating (e.g., the user has precise hand-eye coordination). Accordingly, the media guidance application will register a user interaction with media object 522 only if the user touches media object 522 as shown on the display screen (e.g., display 312 (FIG. 3)) of the user device (e.g., user equipment device 402, 404, and/or 406 (FIG. 4)), upon which the media guidance application is generating (e.g., via control circuitry 304 (FIG. 3)) display 520.

Third, the media guidance application has customized the functions provided by display 520. For example, display 520 allows playback operations (e.g., by selecting media object 522), search and filter operations (e.g., via media object 528), scrolling operations (e.g., via media object 526), and posting on-line (e.g., via media object 524). Fourth, the media guidance application has customized the media assets (e.g., media object 522) of display 520 by displaying media assets recommended for teenagers and that are available only upon paying a fee.

Finally, the media guidance application has customized the design elements of display 500 by removing most textual indicators of required user interactions (e.g., touching touch-screen buttons) to manipulate particular media objects, with the exception of more complicated operations such as posting comments on-line (e.g., media object 524) and searching and/or filtering (e.g., media object 528). It should be noted that in some embodiments, more textual or graphical indicators may be added or removed. For example, in some embodiments, media object 526 (i.e. a scroll bar) may be removed if the media guidance application determines that the user does not require it to interact with the media guidance application or a display (e.g., display 520) as seen on a display screen (e.g., display 312 (FIG. 3)) of a user device (e.g., user equipment device 402, 404, and/or 406 (FIG. 4)).

FIGS. 5A-C also show how the media guidance application may assign different user input interface types to manipulate the same media objects based on a demographic category of the user. For example, media asset 502 appears in FIGS. 5A-C. In FIG. 5A, media asset 502 may be automatically presented. This corresponds to the media guidance application determining that a user in this demographic category (e.g., a young child) likely does not have the dexterity and/or interface comprehension to manipulate the user interface to search for media asset 502.

In FIG. 5B, media asset 502 may be presented following swipes of the user interface (e.g., triggering scrolling functions). This corresponds to the media guidance application determining that a user in this demographic category (e.g., adolescent child) likely has the dexterity and/or interface comprehension to manipulate the user interface to search for media asset 502 via simple swipes.

In FIG. 5C, media asset 502 is presented following a textual input into a search box (e.g., via media object 528). This corresponds to the media guidance application determining that a user in this demographic category (e.g., a teenage) likely has the dexterity and/or interface comprehension to manipulate the user interface to search for media asset 502 via textual inputs, which require reading and writing abilities.

It should be noted that in some embodiments, the media guidance application may assign different user input interface type to manipulate the same media object based on a demographic category of the user. For example, in some embodiments, media asset 502 may be manipulated by a user depressing a physical button on a remote control, may be manipulated by a user touching an area corresponding to the media object on a touch-screen, be manipulated by a user waving a their hand (e.g., in the case of motion-sensed inputs), be manipulated by a user waving a controller (e.g., in the case of a motion-control input), be manipulated by a user verbally speaking a request (e.g., in the case of a voice command input), etc. In each case, the media guidance application may determine a demographic category of the user and assign a suitable user input interface.

For example, if the media guidance application determines that a user (e.g., in a physically-disabled demographic category) has low dexterity, but high interface comprehension, the media guidance application may assign user input interface types that require less physical interactions with an input device, but are more complicated to understand (e.g., registering specific voice commands). If the media guidance application determines that a user (e.g., in an mentally-disabled demographic category) has high dexterity, but low interface comprehension, the media guidance application may assign user input interface types that require more physical interactions with an input device, but are less complicated, for example are more intuitive, to understand (e.g., touch-screen or physical buttons).

FIG. 6 is a flowchart of illustrative steps for customizing a user input interface type based on a demographic of a user. Process 600 may be used to customize a user input interface (e.g., display 500 (FIG. 5A)) on a display device (e.g., display 312 (FIG. 3)). It should be noted that process 600, or any step thereof, could occur on, or be provided by, any of the devices shown in FIGS. 3-4. For example, process 600 may be executed by control circuitry 304 (FIG. 3) as instructed by the media guidance application (e.g., implemented on any of the devices shown and described in FIG. 4).

At step 602, the media guidance application determines a demographic category of a user. For example, as described in step 702 of FIG. 7 below, the media guidance application may receive and interpret demographic data about the user to determine a demographic category of the user. For example, demographic data (e.g., as received via user input interface 310 (FIG. 3)) may indicate that a user is a particular age, has a particular skill set (or lack thereof), or has a disability. Based on this information, the media guidance application determines a particular demographic associated with the user.

At step 604, the media guidance application automatically selects a user input interface type, which defines a type of user interaction for manipulating a media object, based on the determined demographic category. For example, the media guidance application may incorporate or have access to a local (e.g., located at storage 308 (FIG. 3)) or remote (e.g., located at media content source 416 (FIG. 4)), media guidance data source 418 (FIG. 4), and/or a device/location accessible via communications network 414 (FIG. 4)) database (e.g., a lookup table) in which the media guidance application may query (e.g., request a suitable user input interface type for a determined demographic category) to determine which user input interface type to assign to a given media object.

For example, Table 1 below provides an illustrative example of a database with which the media guidance application could cross-reference a determined demographic category (e.g., an age) of a user to determine the user input interface types available.

TABLE 1

| | | | Highest | |
|---|---|---|---|---|
| Demographic | | | User Input | |
| Category | Highest | Highest | Interface | Highest |
| (Based on | Function | Content | Type | Graphic Design |
| Age) | Available | Available | Available | Available |
| Under 2 | Play | Audio/video | Physical | Colors, Shapes |
| years old | | | buttons | |
| 2-3 years | Play, | Simple text | Touch- | Images |
| old | pause, | | screen | |
| | stop video | | buttons | |
| 3-6 years | Basic | Textual | Touch- | Images & |
| old | search, | sentences | screen | simple text |
| | create | | swipes, | |
| | avatar | | track- | |
| | | | ball, | |
| | | | mouse, | |
| | | | keyboard, | |
| | | | voice | |
| | | | control | |
| 6-9 years | On-line | Textual | Touch | Complex text, |
| old | posting, | paragraphs | screen | shadowing, |
| | recording | | pinch, | highlighting |
| | media | | motion- | |
| | | | control, | |
| | | | motion- | |
| | | | sensing | |
| 9-11 years | Order PPV | All | All | Advertisements |
| old | | available | | |
| | | content | | |

At step 606, the media guidance application assigns the automatically selected user input interface type to the media object. For example, in response to determining that the user is in a demographic category of “2-3 years old” as indicated in Table 1, the media guidance application may assign only touch-screen buttons to various media objects on a display screen (e.g., display 312 (FIG. 3)) of the user device (e.g., user equipment device 402, 404, and/or 406 (FIG. 4)), upon which the media guidance application is generating (e.g., via control circuitry 304 (FIG. 3)) a display (e.g., display 500 (FIG. 5)).

At step 608, the media guidance application receives the type of user interaction that was assigned to manipulate the media object. For example, in response to assigning a voice control user input interface type to select a media asset, the media guidance application selects the media asset upon receiving a voice command from the user.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method.

FIG. 7 is a flowchart of illustrative steps for assigning a particular user input interface type to a media object. Process 700 may be used to assign a particular user input interface type (e.g., motion-control) to a media object (e.g., media object 508 (FIG. 5A)) on a display device (e.g., display 312 (FIG. 3)). It should be noted that process 700, or any step thereof, could occur on, or be provided by, any of the devices shown in FIGS. 3-4. For example, process 700 may be executed by control circuitry 304 (FIG. 3) as instructed by the media guidance application (e.g., implemented on any of the devices shown and described in FIG. 4).

At step 702, the media guidance application receives demographic data about a user. For example, the media guidance application may actively or passively monitor the user to build a profile of demographic data of the user. For example, the media guidance application may receive demographic data via user inputs describing the user. In some embodiments, this information may be stored in a user profile associated with the user. Upon initiating the customized user interface (e.g., upon selecting selectable option 204 (FIG. 2)), the media guidance application (e.g., via control circuitry 304 (FIG. 3)) may retrieve the user profile. Additionally or alternatively, the media guidance application may request a user enter a password or other login information to associate the current user with a stored profile.

At step 704, the media guidance application inputs the demographic data into a database (e.g., a lookup table) to determine a demographic category of the user, and at step 706, the media guidance application receives an output of the database (e.g., the lookup table) indicating the demographic category of the user. For example, if the media guidance application (e.g., via input interface 310 (FIG. 3)) receives demographic data indicating that the user is eight years old, the media guidance application may input the age of the user into a database (e.g., corresponding to Table 1 above), which indicates a demographic category of six to nine years old (e.g., as indicated in Table 1).

At step 708, the media guidance application cross-references the determined demographic category of a user with a database to identify user input interface types. For example, the user may be classified as a adolescent child, and in response, the media guidance application may present display and user input types (FIG. 5B) based on a cross-reference indicating that the user has the dexterity and interface comprehension to interact with media objects using touch-screen buttons and swipes.

At step 708, the media guidance application retrieves one of the user input interface types identified in the cross-reference. For example, the media guidance application may (e.g., via control circuitry 304 (FIG. 3)) identify multiple user input interface types that are suitable for a user in the demographic category. In some embodiments, the media guidance application may (e.g., via control circuitry 304 (FIG. 3)) proceed to assign (e.g., as described in step 606 (FIG. 6)) the suitable user input interface types to various media objects in a display (e.g., display 500 (FIG. 5A)). For example, as described in relation to process 600 (FIG. 6)), in some embodiments, the media guidance application may assign the automatically selected user input interface type to a media object.

At step 710, the media guidance application retrieves one of the identified user input interface types. For example, in some embodiments, the media guidance application may (e.g., via control circuitry 304 (FIG. 3)) compare the dexterity of a user to the amount of dexterity needed by a user of the retrieved user input interface type. For example, in some embodiments, the user input interface types identified in the database cross-referenced in step 708 may be compared to the dexterity and interface comprehension of the user to ensure the user is capable of performing the user interactions necessary to manipulate media objects.

At step 712, the media guidance application retrieves a threshold dexterity rating for the retrieved user input interface type, which indicates a level of coordination necessary to perform user interactions necessary to manipulate media objects with the retrieved user input interface type. In some embodiments, the threshold dexterity rating for the retrieved user input interface type may be based on industry standards, manufacture suggestions, surveys, and/or other suitable methods. In some embodiments, the threshold dexterity rating for the retrieved user input interface type may be retrieved from a local (e.g., storage 308 (FIG. 3) of a user device (e.g., user equipment device 402, 404, and/or 406 (FIG. 4)) or remote (e.g., media content source 416 (FIG. 4), media guidance data source 418 (FIG. 4), and/or any location accessible via communication network 414 (FIG. 4)) database.

At step 714, the media guidance application retrieves a dexterity rating for the user, which indicates a level of coordination of a user. In some embodiments, the dexterity rating may be based on the demographic category, a user profile, an initial survey, and/or other suitable methods. In some embodiments, the dexterity rating may be retrieved from a local (e.g., storage 308 (FIG. 3) of a user device (e.g., user equipment device 402, 404, and/or 406 (FIG. 4))) or remote (e.g., media content source 416 (FIG. 4), media guidance data source 418 (FIG. 4), and/or any location accessible via communication network 414 (FIG. 4)) database.

At step 716, the media guidance application compares the dexterity rating for the user to the threshold dexterity rating for the user input interface type. If the dexterity rating for the user does not exceed the threshold dexterity rating, the media guidance application proceeds to step 718 and retrieves a different user input interface type of the identified user input interface types. If it does exceed the threshold dexterity rating, the media guidance application proceeds to step 720. In some embodiments, the media guidance application continuously or periodically (e.g., upon each initialization of the media guidance application) compares the dexterity rating for the user to the threshold dexterity rating. For example, the media guidance application may continually track the progress of the user to ensure that user input interface type is suitable for the dexterity of the user.

In some embodiments, as discussed below, the dexterity rating, interface comprehension level, and/or demographic category and any changes thereto may be included in a user profile associated with the user. In some embodiments, the media guidance application may update the user profile upon receiving any demographic data or any other information received either actively or passively about the user. For example, upon detecting multiple erroneous inputs, the media guidance application may adjust (e.g., decrease) the dexterity rating, interface comprehension level, and/or demographic category associated with the user.

At step 720, the media guidance application retrieves a threshold interface comprehension level for the retrieved user input interface type, which quantifies a level of comprehension users need to have to understand the user input interface type. In some embodiments, the threshold interface comprehension level for the retrieved user input interface type may be based on industry standards, manufacturer suggestions, surveys, and/or other suitable methods. In some embodiments, the threshold interface comprehension level for the retrieved user input interface type may be retrieved from a local (e.g., storage 308 (FIG. 3) of a user device (e.g., user equipment device 402, 404, and/or 406 (FIG. 4))) or remote (e.g., media content source 416 (FIG. 4), media guidance data source 418 (FIG. 4), and/or any location accessible via communication network 414 (FIG. 4)) database.

At step 722, the media guidance application retrieves an interface comprehension level for the user, which indicates a level of comprehension of the user with regard to user interfaces. In some embodiments, the interface comprehension level may be based on the demographic category, a user profile, an initial survey, and/or other suitable methods. For example, if one or more user input interface types are not typically used in the location of a user or by the demographic associated with the user, the interface comprehension level of a user may be lowered. In some embodiments, the interface comprehension level of the user may be retrieved from a local (e.g., storage 308 (FIG. 3) of a user device (e.g., user equipment device 402, 404, and/or 406 (FIG. 4))) or remote (e.g., media content source 416 (FIG. 4), media guidance data source 418 (FIG. 4), and/or any location accessible via communication network 414 (FIG. 4)) database.

At step 724, the media guidance application compares the interface comprehension level for the user to the threshold interface comprehension level for the user input interface type. If the interface comprehension level for the user does not exceed the threshold interface comprehension level, the media guidance application proceeds to step 718 and retrieves (e.g., via control circuitry 304 (FIG. 3)) a different user input interface of the identified user input interface types. If it does exceed the threshold dexterity rating, the media guidance application proceeds to step 726.

At step 726, the media guidance application assigns the retrieved user input interface type a media object. For example, in response to determining that the user has both the dexterity and comprehension level necessary to perform the user interactions necessary to manipulate the media object, the media guidance application assigns (e.g., via control circuitry 304 (FIG. 3)) the user input interface to a media object.

In some embodiments, the media guidance application may cross-reference the suitable user input interface types with a database of control schemes in order to map the suitable user input interface types to the various media objects in the most efficient manner. For example, the media guidance application may query a local (e.g., storage 308 (FIG. 3)) or remote (media guidance data source 418 (FIG. 4)) database for a suitable control scheme to map to the selectable media objects (e.g., media object 508 (FIG. 5A)) in the current display (e.g., display 500 (FIG. 5)) on the display screen (e.g., display 312 (FIG. 3)) of the user device (e.g., user equipment device 402, 404, and/or 406 (FIG. 4)) that the media guidance application (e.g., via control circuitry 304 (FIG. 3)) is generating.

Additionally or alternatively, the media guidance application may determine a current user input interface type based at least in part on a prior user input interface type used by the user. For example, the media guidance application may retrieve a control scheme typically used by the current user. Alternatively or additionally, the media guidance application (e.g., via control circuitry 304 (FIG. 3)) may track the progress of the user to determine whether or not a user should have access to additional user input interface types. For example, in response to determining that a user has dexterity and/or interface comprehension above or below his or her demographic category, the media guidance application may adjust the given demographic category or user input interface types corresponding to that demographic category.

For example, the pace of evolution of the user input interface types may be increased or decreased based on a user's skills in using various user input interface types (e.g., the accuracy with which the user carries out touch-screen interactions, the time taken to complete a set of functions, etc.). Accordingly, the media guidance application may also revert to previously used or less difficult user input interface types if the user repeatedly has difficulty with a particular user interaction necessary to manipulate a media object under a particular user input interface type.

In some embodiments, the media guidance application may also feature games or tutorials to test and/or train users in various user input interface types. In some embodiments, to maintain the usability of the media guidance application, it is important that the user input interface type, media asset, function, and design element changes are gradual, with interim steps where necessary, so that one user input interface type, media asset, function, or design element slowly (and almost imperceptibly) morphs into another user input interface type, media asset, function, or design element.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method of manipulating media objects through customized user input interfaces, the method comprising:
determining, with a user equipment device, a demographic category of a user, wherein the user equipment device has a plurality of user input interface types;
automatically selecting either a first user input interface type or a second user input interface type based on the determined demographic category, wherein the first user input interface type defines a first type of user interaction for manipulating a media object and the second user input interface type defines a second type of user interaction for manipulating the media object;
in response to automatically selecting the first user input interface, assigning the first user input interface type to the media object; and
receiving the first type of user interaction to manipulate the media object.

2. The method of claim 1, wherein selecting either the first user input interface or the second user input interface based on the determined demographic category further comprises:
determining a dexterity rating for the user based on the demographic category, wherein the dexterity rating indicates a level of coordination of the user;
comparing the dexterity rating for the user to a threshold dexterity rating for the first user input interface type, wherein the threshold dexterity rating indicates a level of coordination necessary to use the first user input interface type; and
in response to determining that the dexterity rating for the user exceeds the threshold dexterity rating, selecting the first user input interface.

3. The method of claim 1, wherein selecting either the first user input interface or the second user input interface based on the determined demographic category further comprises:
determining an interface comprehension level for the user based on the demographic category;
comparing the interface comprehension level to a threshold interface comprehension level for the first user input interface type, wherein the threshold interface comprehension level quantifies a level of comprehension users need to have to understand the first user input interface type; and
in response to determining that the interface comprehension level for the user exceeds the threshold interface comprehension level, selecting the first user input interface type.

4. The method of claim 3, wherein the threshold interface comprehension level for the first user input interface type is greater than a threshold interface comprehension level for the second user input interface type.

5. The method of claim 1 further comprising determining a current user input interface type based at least in part on a prior user input interface type used by the user.

6. The method of claim 1, wherein the user interface type is at least one of motion-control interactions, touch-screen interactions, swipe interactions, drag and drop interactions, pinch and expand interactions, and text entry interactions.

7. The method of claim 1 further comprising:
cross-referencing the demographic category of the user with a database associated with interface functions to identify an interface function for performing on the media object suitable for the demographic category; and
selecting the identified interface function.

8. The method of claim 4, wherein the interface function includes playing the media object, performing playback alteration operation on the media object, searching for the media object, posting the media object on-line, generating recommendations featuring the media object, enabling parental control features associated with the media object, downloading the media object, or enabling display of the media object on another device.

9. The method of claim 1 further comprising:
cross-referencing the demographic category of the user with a database associated with interface media assets to identify an interface media asset suitable for the demographic category; and
selecting the identified interface media asset.

10. The method of claim 1 further comprising:
cross-referencing the demographic category of the user with a database associated with interface design elements to identify an interface design element suitable for the demographic category; and
selecting the identified design element.

11. A system of manipulating media objects through customized user input interfaces, the system comprising control circuitry configured to:
determine a demographic category of a user, wherein the user equipment device has a plurality of user input interface types;
automatically select either a first user input interface type or a second user input interface type based on the determined demographic category, wherein the first user input interface type defines a first type of user interaction for manipulating a media object and the second user input interface type defines a second type of user interaction for manipulating the media object;
in response to automatically selecting the first user input interface, assign the first user input interface type to the media object; and
receive the first type of user interaction to manipulate the media object.

12. The system of claim 11, wherein selecting either the first user input interface or the second user input interface based on the determined demographic category further comprises:
determining a dexterity rating for the user based on the demographic category, wherein the dexterity rating indicates a level of coordination of the user;
comparing the dexterity rating for the user to a threshold dexterity rating for the first user input interface type, wherein the threshold dexterity rating indicates a level of coordination necessary to use the first user input interface type; and
in response to determining that the dexterity rating for the user exceeds the threshold dexterity rating, selecting the first user input interface.

13. The system of claim 11, wherein selecting either the first user input interface or the second user input interface based on the determined demographic category further comprises:
determining an interface comprehension level for the user based on the demographic category;
comparing the interface comprehension level to a threshold interface comprehension level for the first user input interface type, wherein the threshold interface comprehension level quantifies a level of comprehension users need to have to understand the first user input interface type; and
in response to determining that the interface comprehension level for the user exceeds the threshold interface comprehension level, selecting the first user input interface type.

14. The system of claim 13, wherein the threshold interface comprehension level for the first user input interface type is greater than a threshold interface comprehension level for the second user input interface type.

15. The system of claim 11, wherein the control circuitry is further configured to determine a current user input interface type based at least in part on a prior user input interface type used by the user.

16. The system of claim 11, wherein the user interface type is at least one of motion-control interactions, touch-screen interactions, swipe interactions, drag and drop interactions, pinch and expand interactions, and text entry interactions.

17. The system of claim 11, wherein the control circuitry is further configured to:
cross-reference the demographic category of the user with a database associated with interface functions to identify an interface function for performing on the media object suitable for the demographic category; and
select the identified interface function.

18. The system of claim 14, wherein the interface function includes playing the media object, performing playback alteration operation on the media object, searching for the media object, posting the media object on-line, generating recommendations featuring the media object, enabling parental control features associated with the media object, downloading the media object, or enabling display of the media object on another device.

19. The system of claim 11, wherein the control circuitry is further configured to:
cross-reference the demographic category of the user with a database associated with interface media assets to identify an interface media asset suitable for the demographic category; and
select the identified interface media asset.

20. The system of claim 11, wherein the control circuitry is further configured to:
cross-reference the demographic category of the user with a database associated with interface design elements to identify an interface design element suitable for the demographic category; and
select the identified design element.

21. A system of manipulating media objects through customized user input interfaces, the system comprising:
means for determining, with a user equipment device, a demographic category of a user, wherein the user equipment device has a plurality of user input interface types;
means for automatically selecting either a first user input interface type or a second user input interface type based on the determined demographic category, wherein the first user input interface type defines a first type of user interaction for manipulating a media object and the second user input interface type defines a second type of user interaction for manipulating the media object;
in response to automatically selecting the first user input interface, means for assigning the first user input interface type to the media object; and
means for receiving the first type of user interaction to manipulate the media object.

22. The system of claim 21, wherein selecting either the first user input interface or the second user input interface based on the determined demographic category further comprises:
means for determining a dexterity rating for the user based on the demographic category, wherein the dexterity rating indicates a level of coordination of the user;
means for comparing the dexterity rating for the user to a threshold dexterity rating for the first user input interface type, wherein the threshold dexterity rating indicates a level of coordination necessary to use the first user input interface type; and
in response to determining that the dexterity rating for the user exceeds the threshold dexterity rating, means for selecting the first user input interface.

23. The system of claim 21, wherein selecting either the first user input interface or the second user input interface based on the determined demographic category further comprises:
means for determining an interface comprehension level for the user based on the demographic category;
means for comparing the interface comprehension level to a threshold interface comprehension level for the first user input interface type, wherein the threshold interface comprehension level quantifies a level of comprehension users need to have to understand the first user input interface type; and
in response to determining that the interface comprehension level for the user exceeds the threshold interface comprehension level, means for selecting the first user input interface type.

24. The system of claim 23, wherein the threshold interface comprehension level for the first user input interface type is greater than a threshold interface comprehension level for the second user input interface type.

25. The system of claim 21 further comprising determining a current user input interface type based at least in part on a prior user input interface type used by the user.

26. The system of claim 21, wherein the user interface type is at least one of motion-control interactions, touch-screen interactions, swipe interactions, drag and drop interactions, pinch and expand interactions, and text entry interactions.

27. The system of claim 21 further comprising:
means for cross-referencing the demographic category of the user with a database associated with interface functions to identify an interface function for performing on the media object suitable for the demographic category; and
means for selecting the identified interface function.

28. The system of claim 24, wherein the interface function includes playing the media object, performing playback alteration operation on the media object, searching for the media object, posting the media object on-line, generating recommendations featuring the media object, enabling parental control features associated with the media object, downloading the media object, or enabling display of the media object on another device.

29. The system of claim 21 further comprising:
means for cross-referencing the demographic category of the user with a database associated with interface media assets to identify an interface media asset suitable for the demographic category; and
means for selecting the identified interface media asset.

30. The system of claim 21 further comprising:
means for cross-referencing the demographic category of the user with a database associated with interface design elements to identify an interface design element suitable for the demographic category; and
means for selecting the identified design element.
